(19) United States
(12) Patent Application Publication
(10) Pub. No.: US 2023/0068864 A1
(43) Pub. Date: Mar. 2, 2023

(54) SHARED DATA FOR NETWORK TENANTS

(71) Applicant: SAP SE, Walldorf (DE)

(72) Inventors: Daniel BRINKMANN, Weinheim (DE); Jens REBHOLZ, Weyher (DE)

(21) Appl. No.: 17/463,721

(22) Filed: Sep. 1, 2021

(51) Int. Cl. G06F 9/50; G06F 16/23; G06F 16/27; G06F 9/455

(52) U.S. Cl. CPC G06F 9/5072; G06F 16/2308; G06F 16/27; G06F 9/45558; G06F 2009/45579; G06F 2009/45595

(57) ABSTRACT

Systems and methods provide a common data container storing common data, a first data container storing first data associated with a first tenant, where the first container is accessible only to the first tenant, and where the first container is associated with read access to the common data of the common data container, and a second data container storing second data associated with a second tenant, where the second container is accessible only to the second tenant, and where the second container is associated with read access to the common data of the common data container, and where the common data container is not accessible to the first tenant or to the second tenant.

### BACKGROUND

Conventional database systems store large volumes of data related to many aspects of an enterprise. Applications may provide this data to users belonging to different departments or divisions of the enterprise, to partner entities (e.g., suppliers, customers), or to any other entities. The data typically includes data which is common to all entities, as well as data specific to each entity. Various systems are employed to ensure that each user of each entity may only access the data which the user is authorized to access.

In one example depicted in FIG. 1A, persistent data storage 11 (which may be a distributed storage system) stores monolithic data 10. Application 12 accesses monolithic data 10 based on commands received from corresponding user interface components 14, which are operated by users of each entity to which application 12 grants access. Monolithic data 10 includes data common to all entities and data specific to each entity. During operation, application 12 accesses authorization component 16 to ensure that each user of each entity only receives portions of data 10 which they are authorized to receive. This architecture requires complex definition and maintenance of roles, access control lists, and the like, as well as of the authorization logic required to properly enforce the roles, access control lists, etc. Errors may lead to data leakage across users of a given entity or across entities, both of which are particularly troublesome in view of business concerns and data privacy regulations.

The architecture of FIG. 1B illustrates physical separation of application data 22, 23 and 24, each of which corresponds to a separate entity and also includes common data 20. For example, application data 22 includes data associated with a single entity and common data 20, and users of that entity access application data 22 via application 25. Accordingly, the users of each entity are prevented from accessing data of another entity. The FIG. 1B architecture inefficiently requires duplication of common data 20 within each of application data 22, 23 and 24, and complex synchronization to account for changes to common data 20 which might occur within storage 21 or within any of application data 22, 23 and 24.

Systems are desired to efficiently provide common data to disparate entities while isolating entity-specific data adaptations and mappings.

### BRIEF DESCRIPTION OF THE DRAWINGS

FIG. TA illustrates a prior art database system architecture.

FIG. 1B illustrates a prior art database system architecture.

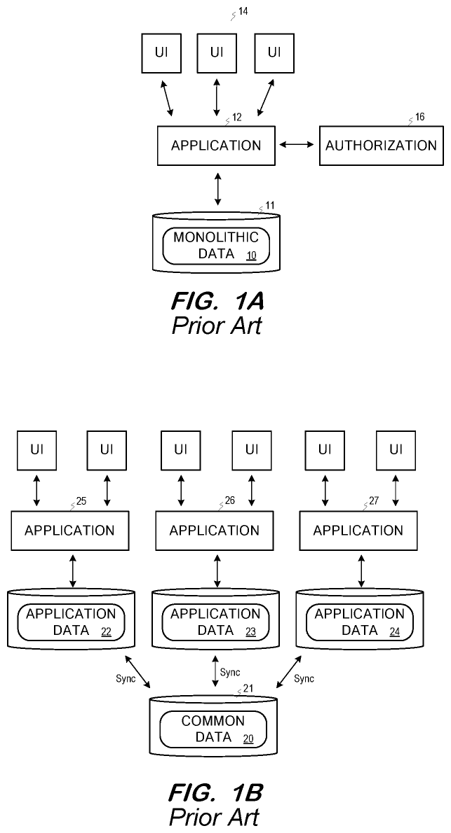

FIG. 2 illustrates a multi-tenant database system architecture according to some embodiments.

FIG. 3 illustrates cross-container object access according to some embodiments.

FIG. 4 illustrates a multi-tenant database system design-time architecture according to some embodiments.

FIG. 5 illustrates a multi-tenant database system run-time architecture according to some embodiments.

FIG. 6 illustrates a multi-tenant database system design-time architecture according to some embodiments.

FIG. 7 illustrates a cloud-based multi-tenant database system architecture according to some embodiments.

FIG. 8 is a block diagram of a computing system according to some embodiments.

### DETAILED DESCRIPTION

The following description is provided to enable any person in the art to make and use the described embodiments. Various modifications, however, will remain readily-apparent to those in the art.

Some embodiments utilize a common container for storing common data and tenant-specific containers for storing tenant-specific data. The common container may reside in a single tenant system, while the tenant-specific data is managed by a multi-tenant-enabled system including multi-tenant applications and storage. Each tenant-specific container may access common data of the common container using a grant mechanism. According to some embodiments, upon receipt of a request from a user of a given tenant, a multi-tenant application may efficiently and transparently consume common data directly from the common container and tenant-specific data directly from the tenant-specific container associated with the given tenant. The common data may also include data structures which allow inter-tenant discovery and communication.

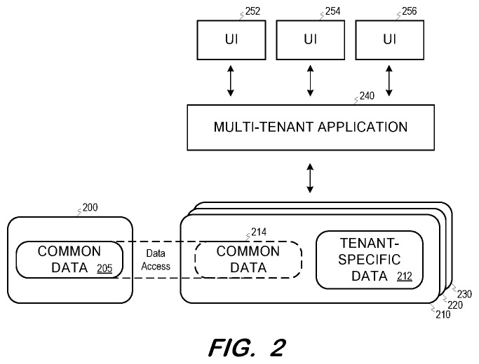

FIG. 2 illustrates a multi-tenant architecture according to some embodiments. Container 200 stores common data 205. Container 200 may be seen as hardware-based storage (e.g., one or more hard disk drives and/or Random Access Memory (RAM) modules), as software providing data access and management), or any combination thereof. Generally, container 200 is compatible with a data access mechanism which allows other containers to access common data 205.

Container 210 includes tenant-specific data 212. Tenant-specific data 212 may be data which should only be accessed by a particular tenant (i.e., by users of the particular tenant) and not by any other tenant. Containers 220 and 230 are also tenant-specific and include respective tenant-specific data (not shown).

Common data 214 of container 210 represents common data 205 accessed via the above-mentioned data access mechanism. Accordingly, a tenant associated with container 210 may access both tenant-specific data 212 and common data 214/205. A tenant associated with container 220 (or 230) may similarly access the tenant-specific data of container 220 (or 230) and common data 205.

Multi-tenant application 240 may comprise program code providing any suitable functionality. Multi-tenant application 240 may be deployed on-premise, in the cloud, or in any manner that is or becomes known. Multi-tenant application 240 provides functionality to users of disparate tenants using tenant-specific containers 210, 220 and 230.

For example, a user associated with a first tenant may access UI component 252 to forward a request to multi-tenant application 240. Multi-tenant application 240 determines that the user is associated with the first tenant (e.g., via an authorization token) and serves the request based only on the tenant-specific and common data stored within the container (e.g., container 210) associated with the first tenant. In a case that a user associated with a second tenant accesses UI component 254 to forward a second request to multi-tenant application 240, multi-tenant application 240 determines that the user is associated with the second tenant and serves the second request based only on the tenant-specific and common data stored within the container (e.g., container 220) associated with the second tenant. Systems may include several different multi-tenant applications, each of which access containers 210, 220 and 230 as described above.

According to some embodiments, each of containers 200, 210, 220 and 230 consists of a design-time container to store design-time artifacts (i.e., representations of catalog objects to be created during deployment) and a corresponding run-time container to store catalog objects built according to the representations. The transformation of design-time artifacts into corresponding run-time catalog objects may be performed by so-called plug-ins, access to which may be defined by a container configuration file according to some embodiments. Generally, the configuration file for a container may map each design-time artifact type to a plug-in for building run-time catalog objects therefrom.

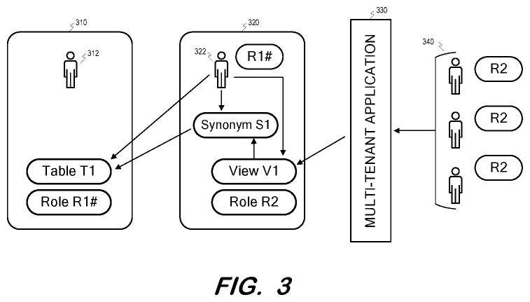

FIG. 3 illustrates a mechanism for granting a container (e.g., a tenant-specific container) access to data of a separate container (e.g., a “common” container) which may be used in some embodiments. Container 310 represents a common container controlled by common owner 312 and container 320 represents a tenant-specific container controlled by tenant 322. It will be assumed that Table T1 of container 310 includes data to be accessed by container 320. Embodiments are not limited to the FIG. 3 mechanism.

According to the present example, owner 312 creates Table T1 and Role R1# in container 310. Role R1# assigns the SELECT privilege on Table T1. Next, owner 322 is assigned to Role R1#. Synonym Si is created in container 320 and associated with Table T1. View V1 referencing Synonym Si is created in container 320 and Role R2 defines privileges required by an application user to access View V1. Users 340 of multi-tenant application 330 which are assigned to Role R2 may then, via multi-tenant application 330, access Table T1 of container 310 through View V1 of container 320. Rather than Table T1, a shared object of common container 310 may comprise a view, a function, a procedure, etc.

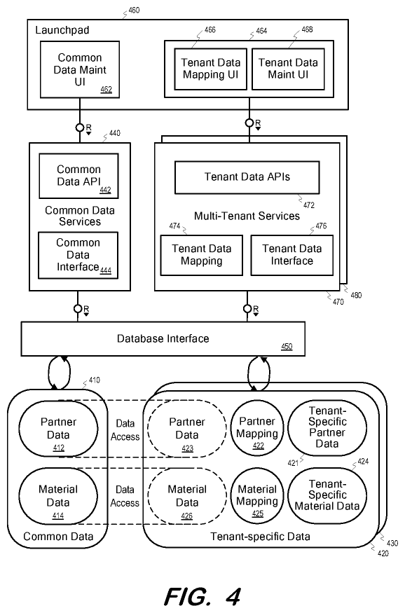

FIG. 4 illustrates a multi-tenant architecture according to some embodiments. Common data container 410 includes data to be shared with multiple tenant-specific containers 420 and 430. The shared data includes partner data 412 and material repository 414 in the FIG. 4 example. Partner data 412 may include data associated with suppliers, buyers, and other entities, while material data 414 may include data regarding raw materials. Embodiments are not limited to these types of data.

Tenant-specific container 420 includes tenant-specific partner data 421 and tenant-specific material data 424. Tenant-specific partner data 421 may include partner-related data which is defined in any manner suitable to the tenant associated with container 420. The partner-related data of tenant-specific partner data 421 may represent extensions to partner data 412 and need not follow the schema thereof. Similarly, tenant-specific material data 424 may represent extensions to the material data 414 but does not necessarily follow the schema thereof.

Tenant-specific container 420 is also depicted as including reference 423 to partner data 412 and reference 426 to material data 414. The references may comprise views on data 412/414 as described above.

Partner mapping 422 comprises data used to map tenant-specific partner data 421 to partner data 412. Partner mapping 422 advantageously allows a tenant associated with container 420 to use terminology, data formats, data structures, etc. which do not conform to partner data 412, while still associating data 421 with logically-related counterparts of partner data 412 in a manner allowing data 412 to be consumed by a suitable application. Material mapping 425 provides similar links between tenant-specific material data 424 and material data 414.

Common data services 440 may comprise cloud-based executable program code to provide common data API 442 and common data interface 444. Common data API 442 may be invoked by UI components to request operations on data of common data container 410 as well as to define roles, privileges and container configurations associated with the data. Common data API 442 in turn uses common data interface 444 to perform the operations and create the definitions. In this regard, common data interface 444 may access database interface 450 to communicate with common data container 410. In some embodiments, common data services 440 and common data container 410 do not support multi-tenancy because only one tenant is intended to directly access services 440 and container 410, thereby simplifying their implementation and reducing associated costs.

Launchpad 460 includes services which receive browser calls from browsers (not shown) executed by users (not shown) and provide, for example, HyperText Markup Language pages in response. The services may be executed by one or more Web servers, application servers, or the like, deployed on-premise, in the cloud, or in a hybrid arrangement.

In one example, a user operates a Web browser to access a Web page provided by common data maintenance UI 462. The user provides authentication information associated with a tenant sub-account and a subscription to common data services 440. In some embodiments, only one tenant possesses a subscription to common data services 440. The user then interacts with UI 462 to manage container 410 via common data API 442, common data interface 444 and database interface 450.

Launchpad 460 also includes tenant UIs 464, including tenant data mapping UI 466 and tenant data maintenance UI 468. Tenant UIs 464 may be provided by one or more systems which are different from the system providing common data maintenance UI 462.

A user may operate a Web browser to call either of tenant data mapping UI 466 or tenant data maintenance UI 468. The user may provide authentication information for a subscription as described above, and the authentication information is passed to multi-tenant services 472 to determine an associated tenant. In the present example, the determined tenant is associated with one of containers 420 and 430.

The user may thereafter interact with tenant data mapping UI 466 to manage mappings stored within the associated container. In particular, these interactions result in calls to tenant data APIs 472, which in turn call tenant data mapping component 474. Tenant data mapping component 474 accesses database interface 450 to manage data mappings of the container associated with the current tenant.

Tenant data maintenance UI 468 may be accessed to maintain tenant data of a particular tenant-specific container. As described above, the particular container is determined by the subscription information provided by the user. Interaction with tenant data maintenance UI 468 results in calls to tenant data APIs 472, which in turn call tenant data interface 476. Tenant data interface component 476 then accesses database interface 450 to maintain data of the particular container determined by the subscription information.

FIG. 4 illustrates multi-tenant services instances 470 and 480. Each of instances 470 and 480 may be accessed by users associated with any tenant. That is, instances 470 and 480 are not tenant-specific but are provided for load balancing and increased throughput according to some embodiments.

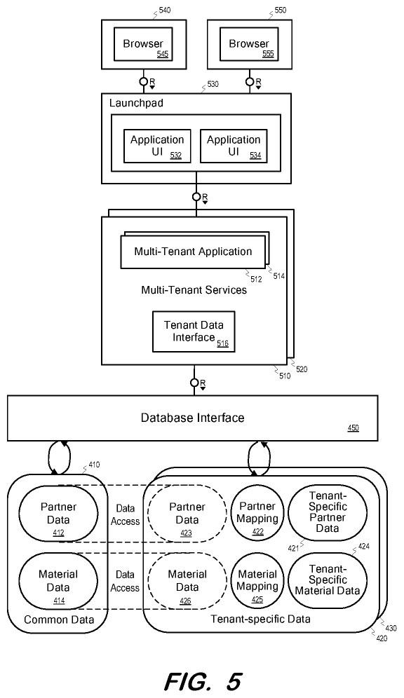

FIG. 5 illustrates a run-time system according to some embodiments. Containers 410, 420 and 430 have been configured as described above with respect to FIG. 4. Multi-tenant services 510 and 520 are identical instances for purposes of load balancing and throughput as described above. Embodiments are not limited to two instances.

Each of multi-tenant services 510 and 520 includes multi-tenant applications 512, 514 and tenant data interface 516 which allows applications 512, 514 to access tenant-specific data of an appropriate tenant-specific container 420 or 430. For example, a user of a first tenant may execute browser 545 of computing device 540, such as a laptop computer, to call application UI component 532 of launchpad 530. It will be assumed that application UI component 532 is associated with multi-tenant application 512. Based on login information provided by the user, multi-tenant services 510 identifies the user as associated with the first tenant.

The user then interacts with application 512 via UI component 532. In case an interaction requires application 512 to access data, application 512 accesses data of the one of tenant-specific containers 420 or 430 which is associated with the first tenant, and does not access the other container. Such access may, as described above, include access to partner data 412 or material data 414 of common data container 410 via a data sharing mechanism as described above. It should be noted that access to partner data 412 or material data 414 from a tenant-specific container does not necessarily include the ability to create, delete or update partner data 412 or material data 414. In some embodiments, one or more partners and/or participants may be granted certain write permissions to contribute to portions of the common data.

A second user of a second tenant may execute browser 555 of computing device 550 to call application UI component 532 of launchpad 530. Based on login information provided by the second user, multi-tenant services 510 identifies the user as associated with the second tenant. In such as case, and in response to interaction of the second user with application UI component 532, application 512 accesses only the tenant-specific data container 420 or 430 which is associated with the second tenant. Again, this access may include access to partner data 412 or material data 414 of common data container 410 via a data sharing mechanism as described above.

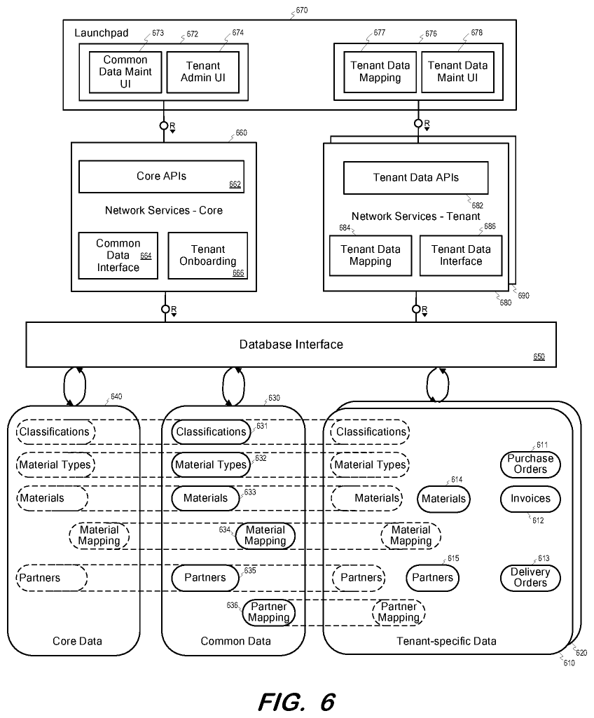

FIG. 6 illustrates an architecture including a plurality of tenant-specific data containers 610 and 620, and common data container 630 as described above. The FIG. 6 architecture also includes core data container 640 which may be accessed to view data shared from and stored in common container 630 as described above. In some implementations, common data container 630 is managed and maintained by a provider of the FIG. 6 architecture, and core data container 640 is associated with a customer who manages the architecture to onboard tenants and the like.

For example, the network provider may access common data maintenance UI component 673 of launchpad 670, which in turn calls core APIs 662 of network services 660 to manage data within container 630 via common data interface 664. The customer, on the other hand, may access tenant administration UI 674 of launchpad 670, to call core APIs 662 to onboard tenants via tenant onboarding component 666. Such onboarding may include, but is not limited to, creating a container for tenant-specific data of a new tenant and deleting a container associated with a tenant that has unsubscribed from the network.

Onboarding may also include storing mappings between the tenant data and common data in common container 630. This is in contrast to the architecture of FIGS. 4 and 5, in which the mappings were stored in tenant-specific containers. Common data container 630 stores material mapping 634 and partner mapping 636, and each tenant-specific container 610 and 620 may access their associated mappings. Such an arrangement may be leveraged to facilitate communication between tenants.

For example, a given tenant may create a purchase order to send to another tenant which includes a material specified in materials 614 of the tenant-specific container associated with the given tenant. Upon receipt of the purchase order, the system may determine a mapping between the material of the given tenant and a material of the other tenant by determining, using material mapping 634, the material of materials 633 to which the material of the given tenant maps, and then determining, again using material mapping 634, the material of the other tenant to which the material of materials 633 maps. The purchase order may then be updated with the corresponding material identifier used by the other tenant and forwarded to the other tenant.

Similarly, partner mapping 636 includes mappings between partners 635 of common data container 630 and partners 615 of each tenant-specific data container 610 and 620. Each tenant-specific container 610 and 620 may also store tenant-specific data such as purchase orders 611, invoices 612 and delivery orders 613 which are not mapped to data of common data container 630.

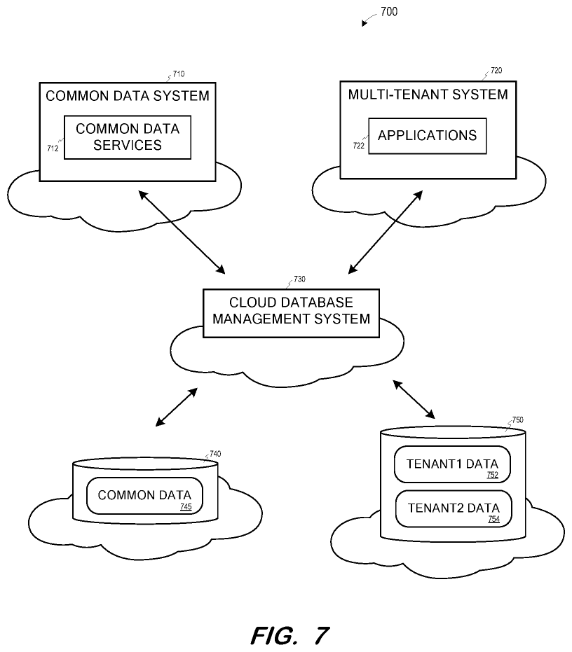

FIG. 7 is a diagram of cloud-based architecture 700 according to some embodiments. Each component of cloud-based architecture 700 may be implemented by any number of distributed servers, storage systems, virtual machines, etc., and the resources allotted to each component may expand or contract elastically as is known in the art of cloud deployments.

Common data system 710 provides common data services 712 to UI applications as described above. Common data services 712 may access cloud database management system 730, which accesses common data 742 of storage 740. Common data 742 may be stored in a single-tenant container as described herein.

Multi-tenant system 720 provides multi-tenant applications 722 which may be accessed by users of different tenants. Applications 722 communicate with cloud database management system 730 to access either tenant1 data 752 or tenant2 data 754 of storage 750 depending upon the tenant of the user being served. Tenant1 data 752 and tenant2 data 754 are stored in separate containers and each may be accessed to access shared data of common data 742 as described above. Although both are depicted as stored in storage 750, tenant1 data 752 and tenant2 data 754 may be stored in separate storage systems in some embodiments.

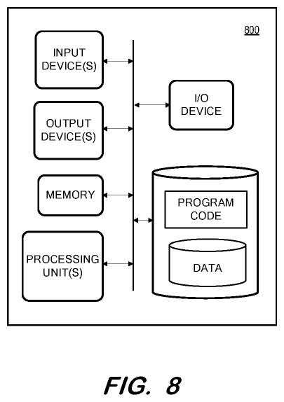

FIG. 8 is a block diagram of system 800 according to some embodiments. System 800 may comprise a general-purpose computing apparatus and may execute program code to perform any of the functions described herein. The elements of system 800 may be distributed across several physical devices, including cloud-based resources, and system 800 may include other unshown elements according to some embodiments.

System 800 includes a processing unit including but not limited to processors, processor cores, and processor threads. Such processors, processor cores, and processor threads may be implemented by a virtual machine provisioned in a cloud-based architecture. The processing unit may execute program code stored along with required data in any non-transitory tangible medium, including combinations of magnetic storage devices (e.g., magnetic tape, hard disk drives and flash memory), optical storage devices. The memory may comprise Random Access Memory (RAM), Storage Class Memory (SCM) or any other fast-access memory.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a common data container storing common data;
a first data container storing first data associated with a first tenant, where the first container is accessible only to the first tenant, and where the first container is associated with read access to the common data of the common data container; and
a second data container storing second data associated with a second tenant, where the second container is accessible only to the second tenant, and where the second container is associated with read access to the common data of the common data container, and
where the common data container is not accessible to the first tenant or to the second tenant.

2. A system according to claim 1, wherein the first data container stores a first view on a database table of the common container, and
wherein the second data container stores a second view on the database table of the common container.

3. A system according to claim 1, further comprising a multi-tenant application to:
receive a first request from a first user associated with the first tenant;
receive a second request from a second user associated with the second tenant;
in response to the first request, determine to access the first data container to access the first data and the common data; and
in response to the second request, determine to access the second data container to access the second data and the common data.

4. A system according to claim 1, further comprising:
a single-tenant storage system to store the common data container; and
a single-tenant application to access the common data container.

5. A system according to claim 4, further comprising:
a multi-tenant storage system to store the first data container and the second data container.

6. A system according to claim 1, wherein the first data comprises first extensions to the common data and the second data comprises second extensions to the common data.

7. A system according to claim 6, wherein the first data comprises first mappings from the first extensions to the common data and the second data comprises second mappings from the second extensions to the common data.

8. A system according to claim 6, wherein the common data comprises mappings from the first extensions to the common data and from the second extensions to the common data.

9. A method comprising:
storing common data in a common data container;
storing first data associated with a first tenant in a first data container, where the first container is accessible only to the first tenant, and where the first container is associated with read access to the common data of the common data container; and
storing second data associated with a second tenant in a second data container, where the second container is accessible only to the second tenant, and where the second container is associated with read access to the common data of the common data container, and
where the common data container is not accessible to the first tenant or to the second tenant.

10. A method according to claim 9, wherein the first data container stores a first view on a database table of the common container, and
wherein the second data container stores a second view on the database table of the common container.

11. A method according to claim 9, further comprising:
receiving, at a multi-tenant application, a first request from a first user associated with the first tenant;
receiving, at the multi-tenant application a second request from a second user associated with the second tenant;
in response to the first request, accessing the first data container to access the first data and the common data; and
in response to the second request, accessing the second data container to access the second data and the common data.

12. A method according to claim 9,
wherein the common data container is stored in a single-tenant storage system.

13. A method according to claim 12,
wherein the first data container and the second data container are stored in a multi-tenant storage system.

14. A method according to claim 9, wherein the first data comprises first extensions to the common data and the second data comprises second extensions to the common data.

15. A method according to claim 14, wherein the first data comprises first mappings from the first extensions to the common data and the second data comprises second mappings from the second extensions to the common data.

16. A method according to claim 14, wherein the common data comprises mappings from the first extensions to the common data and from the second extensions to the common data.

17. A non-transitory medium storing processor-executable program code executable by a processing unit to cause a system to:
store common data in a common data container;
store first data associated with a first tenant in a first data container, where the first container is accessible only to the first tenant, and where the first container is associated with read access to the common data of the common data container; and
store second data associated with a second tenant in a second data container, where the second container is accessible only to the second tenant, and where the second container is associated with read access to the common data of the common data container, and
where the common data container is not accessible to the first tenant or to the second tenant.

18. A medium according to claim 17, the processor-executable program code executable by a processing unit to cause a system to:
receive a first request from a first user associated with the first tenant;
receive a second request from a second user associated with the second tenant;
in response to the first request, access the first data container to access the first data and the common data; and
in response to the second request, access the second data container to access the second data and the common data.

19. A medium according to claim 17, wherein the first data comprises first extensions to the common data and the second data comprises second extensions to the common data, and
wherein the first data comprises first mappings from the first extensions to the common data and the second data comprises second mappings from the second extensions to the common data.

20. A medium according to claim 17, wherein the first data comprises first extensions to the common data and the second data comprises second extensions to the common data, and
wherein the common data comprises mappings from the first extensions to the common data and from the second extensions to the common data.
